(19) United States
(12) Patent Application Publication
(10) Pub. No.: US 2007/0105450 A1
(43) Pub. Date: May 10, 2007

(54) Connecting module

(75) Inventors: Ru-Kuen Huang, Taoyuan Hsien (TW); Yu-Yuan Tai, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/415,188

(22) Filed: May 2, 2006

(30) Foreign Application Priority Data
Nov. 4, 2005 (TW) 094138663

(51) Int. Cl. H01R 24/00

(52) U.S. Cl. 439/676

(57) ABSTRACT

A connecting module includes a plurality of connectors and at least one fastener. These connectors are stacked with each other and each connector has at least one jack for correspondingly receiving an external plug therein. The fastener is disposed between two adjacent connectors so as to assemble the adjacent connectors.

### CROSS REFERENCE TO RELATED APPLICATIONS

This Non-provisional application claims priority under 35 U.S.C. §119(a) on Patent Application No. 094138663 filed in Taiwan, Republic of China on Nov. 4, 2005, the entire contents of which are hereby incorporated by reference.

### BACKGROUND OF THE INVENTION

1. Field of Invention

The invention relates to a connecting module and, in particular, to a stacked connecting module.

2. Related Art

Accompanying the development of the technology, the electronic and the information product, such as a computer system, has widely spread. However, the computer system constructed with few computers or apparatuses is insufficient for providing the convenient information service. Moreover, accompanying the fast development of internet technology, it is the trend of the information age to retrieve information from many distributed computers and apparatuses rapidly through the network. In this case, the computers and the apparatuses distributed around the world are connected through the network.

As mentioned above, the computer system usually employs a connecting module to connect to internet or the related electronic apparatus through the network. Referring to FIG. 1, a conventional connecting module 10 for connecting to the network apparatus has a plurality of connectors 11, which are stackedly and slidingly assembled with each other. Each connector 11 includes a plurality of jacks 111, and each jack 111 is used to couple with a plug 12 of at least one connecting line for transmitting signals. The jack 111 and the plug 12 must be manufactured within standard specifications.

The stacked connectors 11 may misalign (as shown in FIG. 1) when applying an external force to pull the plug 12 away from the jack 111 along a direction D. Since there is no fastener disposed between the stacked connectors 11, the connecting structure of the stacked connectors 11 may be damaged and thus generate a gap 101 (as shown in FIG. 2) when the environmental condition changes or a stress is applied. The damaged connecting structure may lead to the poor contact between the plug 12 and the jack 111, which results in the bad signal transmission quality.

Therefore, it is an important subject to provide a connecting module with a fastened structure to ensure the signal transmission quality.

### SUMMARY OF THE INVENTION

In view of the foregoing, the invention is to provide a connecting module with a reinforced structure so as to ensure the signal transmission quality.

To achieve the above, a connecting module of the invention includes a first connector and a second connector. The first connector has at least one first jack, which correspondingly receives an external plug, and at least one first fastener. The second connector has at least one second jack, which correspondingly receives an another external plug, and at least one second fastener. The first connector connects to the second connector by the first fastener and the second fastener.

In the invention, the first connector of the connecting module further includes a block portion corresponding to a part of the second connector. The part of the second connector contacts against the block portion, so that the block portion can stop the relative sliding between the first connector and the second connector. Herein, the connectors are stacked with each other.

As mentioned above, the connecting module of the invention utilizes at least one fastener for connecting the stacked connectors with each other. The fastener can be disposed between the adjacent connectors. In this case, the first fastener is a recess or a protrusion and the second fastener is correspondingly a protrusion or a recess. The recess and the protrusion are disposed on the opposite surfaces of the connectors, respectively. The connectors are connected with each other by, for example, fastening the recess to the protrusion. The fastener disposed between the adjacent connectors can avoid the warp of the connector or the gap between the connectors. In addition, the connecting module of the invention includes at least one block portion for stopping the stacked connectors sliding relatively, so that the misalignment of the conventional connectors caused by the external force for assembling or disassembling the plugs can be prevented. Therefore, the connecting structure of the connecting module with the fastener is reinforced to ensure the signal transmission quality.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing the conventional connecting module having misaligned connectors;

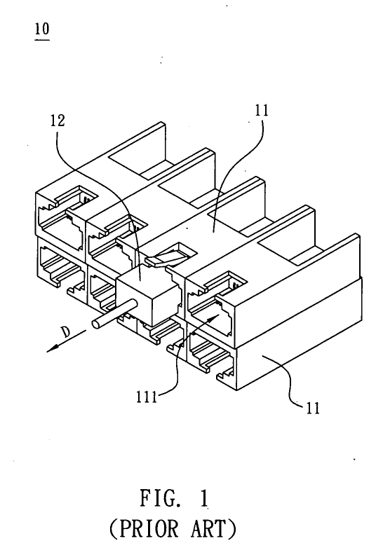

FIG. 2 is an elevation diagram showing the conventional connecting module having a gap;

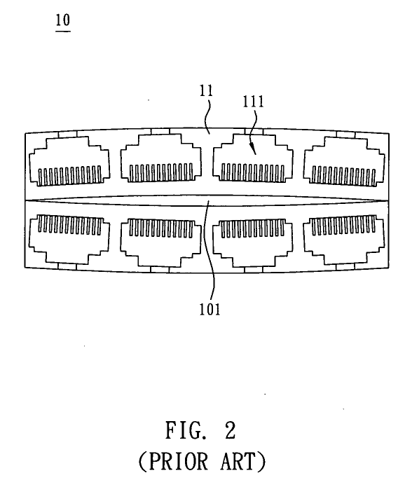

FIG. 3 is an elevation diagram showing a connecting module according to an embodiment of the invention; and

FIG. 4 is a cross-sectional diagram of the connecting module along the line A-A of FIG. 3.

### DETAILED DESCRIPTION OF THE INVENTION

A connecting module according to an embodiment of the invention will be apparent from the following detailed description, which proceeds with reference to the accompanying drawings, wherein the same references relate to the same elements.

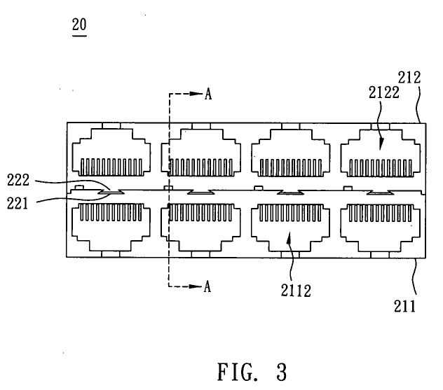

Referring to FIG. 3, a connecting module 20 according to an embodiment of the invention includes a first connector 211 and a second connector 212. The first connector 211 and the second connector 212 are stacked and assembled by relatively sliding.

At least one first jack 2112 corresponding to an external plug is disposed on the first connector 211, and at least one second jack 2122 corresponding to another external plug is disposed on the second connector 212. The openings of the first jack 2112 and the second jack 2122 have the same direction. In practice, the connecting module 20 is not limited in the invention and may be composed by stacking by more than two connectors 211, 212. Besides, the first connector 211 and the second connector 212 may respectively have a plurality of jacks 2112 and 2122 for coupling with corresponding external plugs. In this embodiment, the jacks 2112 and 2122 are manufactured within the specification of RJ-11, RJ-12 or RJ-45.

In the embodiment, a first fastener 221 is disposed on the first connector 211 and a second fastener 222 is disposed on the second connector 212. In this case, the second fastener 222 is disposed opposite to the first fastener 221. The first fastener 221 and the second fastener 222 are respectively disposed opposite to the first jack 2112 and the second jack 2122.

In the embodiment, the first fastener 221 is a trapezoid recess and the second fastener 222 is correspondingly a trapezoid protrusion, which can be contained in the first fastener 221. Since the shapes of the first fastener 221 and the second fastener 222 are compatible, the first connector 211 and the second connector 212 are connected with each other by sliding the second fastener 222 into the first fastener 221.

The first fastener 221 is wedged with the second fastener 222 to prevent the gap between the first connector 211 and the second connector 212 caused by the warped connectors. Additionally, the first connector 211 is assembled or disassembled with the second connector 212 by relatively sliding the second fastener 222 and the first fastener 221.

In this case, the first fastener 221 and the first connector 211 can be integrally formed as a single unit, and the second fastener 222 and the second connector 212 can be integrally formed as a single unit. Additionally, the elevational shape of the first fastener 221 or the second fastener 222 can has a trapezoid, circular, rectangular, polygonal or irregular profile.

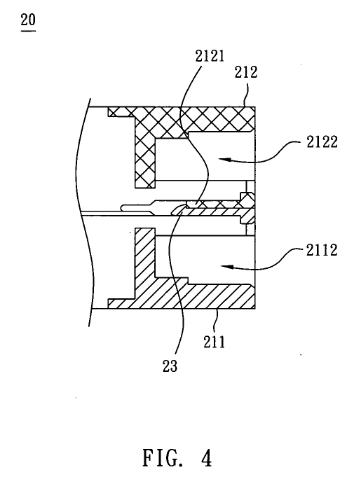

FIG. 4 is a cross-sectional diagram of the connecting module 20 along the line A-A of FIG. 3. Referring to FIG. 4, the first connector 211 further includes a block portion 23 for stopping the first connector 211 sliding along a direction, which is the sliding direction for assembling the second connector 212 and the first connector 211. Additionally, a part 2121 of the second connector 212 contacts against the block portion 23 when the second connector 212 has slidingly assembled with the first connector 211. Therefore, the block portion 23, such as a hook, not only can ensure the first connector 211 and the second connector 212 free from easily disassembling, but also can prevent the first connector 211 and the second connector 212 from misalignment caused by an external force.

In summary, the connecting module of the invention utilizes at least one fastener for connecting the stacked connectors with each other. The fastener can be disposed between the adjacent connectors. In this case, the fastener is a recess or a protrusion, which are disposed on the opposite surfaces of the connectors. The connectors are connected with each other by the recess and the protrusion. Since, the recess is wedged with the protrusion, the warp of the connectors or the gap between the connectors can be prevented. In addition, the connector can also include a block portion to eliminate the misalignment of the conventional connectors caused by the external force for assembling or disassembling the plugs. This can be carried out by stopping the stacked connectors sliding relatively with the block portion. Therefore, the connecting structure of the connecting module with the fastener is reinforced to ensure the signal transmission quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A connecting module, comprising:
a first connector having at least one first jack, at least two first fasteners and a block portion, wherein the first jack correspondingly receives an external plug, the block portion being disposed between the first fasteners; and
a second connector having at least one second jack and at least two second fasteners, wherein the second jack correspondingly receives another external plug, the first connector is assembled with the second connector by a combination of the first fastener and the second fastener, the first fasteners and the second fasteners are engaged by moving the first connector and the second connector along a predetermined direction, and the block portion prevents the first connector and the second connector from being misaligned.

2. The connecting module according to claim 1, wherein the first fastener is a recess and the second fastener is a protrusion slidingly wedged with the recess.

3. The connecting module according to claim 2, wherein the recess or the protrusion has a trapezoid, circular, rectangular, polygonal or irregular profile.

4. The connecting module according to claim 1, wherein the first fastener is a protrusion and the second fastener is a recess slidingly wedged with the protrusion.

5. The connecting module according to claim 4, wherein the recess or the protrusion has a trapezoid, circular, rectangular, polygonal or irregular profile.

6. The connecting module according to claim 1, wherein the first connector and the second connector are stacked.

7. The connecting module according to claim 1, wherein an opening of the first jack and an opening of the second jack have the same open direction.

8. (canceled)

9. The connecting module according to claim 1, wherein a part of the second connector contacts against the block portion.

10. The connecting module according to claim 1, wherein the block portion is a hook.

11. The connecting module according to claim 1, wherein the first fastener and the first connector are integrally formed as a single unit.

12. The connecting module according to claim 1, wherein the second fastener and the second connector are integrally formed as a single unit.

13. The connecting module according to claim 1, wherein the external plug is an RJ-11 plug, an RJ-12 plug, or an RJ-45 plug.

14. A connecting module, comprising:
a plurality of connectors stacked with each other and respectively having a plurality of jacks, wherein each of the jacks correspondingly receives an external plug; and
a plurality of fasteners disposed between every two adjacent connectors for assembling the connectors, wherein each of the fasteners is disposed with respect to each of the jacks, and the fasteners are engaged by moving the two adjacent connectors along a predetermined direction.

15. The connecting module according to claim 14, wherein the fastener is a recess or a protrusion wedged each other.

16. The connecting module according to claim 15, wherein a shape of the protrusion depends on that of the recess.

17. The connecting module according to claim 14, further comprising a block portion disposed between the adjacent connectors for stopping the connectors-sliding relatively.

18. The connecting module according to claim 17, wherein the block portion is a hook.

19. The connecting module according to claim 14, wherein openings of the jacks have the same open direction.

20. The connecting module according to claim 14, wherein each of the external plug is an RJ-11 plug, an RJ-12 plug, or an RJ-45 plug.
